(19) United States
(12) Patent Application Publication
(10) Pub. No.: US 2015/0178531 A1
(43) Pub. Date: Jun. 25, 2015

(54) SENSORY HEAD WITH STORAGE AND POWER

(71) Applicants: Johannes Izak Boerhout, San Diego, CA (US); Jonathan David Murphy, Friday Harbor, WA (US)

(72) Inventors: Johannes Izak Boerhout, San Diego, CA (US); Jonathan David Murphy, Friday Harbor, WA (US)

(21) Appl. No.: 14/554,619

(22) Filed: Nov. 26, 2014

Related U.S. Application Data
(63) Continuation-in-part of application No. 14/136,643, filed on Dec. 20, 2013.
Application No. 14/136,643 is a continuation-in-part of application No. 14/502,142, filed on Sep. 30, 2014.
Application No. 14/502,142 is a continuation-in-part of application No. 14/525,449, filed on Oct. 28, 2014.

(51) Int. Cl. G06K 7/10

(52) U.S. Cl. CPC G06K 7/10366

(57) ABSTRACT

A sensor system, apparatus, and method. The sensor system can include a mobile unit and a sensory head having a power source, wherein the sensory head is releasably coupled with the mobile unit. The sensory head includes at least one sensor that measures one or more characteristics of a test piece. The sensory head is placed in proximity to the test piece, then detached from the mobile unit. While the sensory head is detached from the mobile unit, the at least one sensor can measure the one or more characteristics of the test piece. Measurement date is then uploaded to a remote device. Once measurements are completed, the sensory head is attached to a mobile unit and detached from the test piece. Thus the sensor system, apparatus, and method can measure the characteristic over a period of time while the sensory head is detached from the mobile unit.

### CROSS-REFERENCE TO RELATED APPLICATIONS

This application is a continuation-in-part of U.S. patent application Ser. No. 14/136,643, which was filed on Dec. 20, 2013, and of U.S. patent application Ser. No. 14/502,142, filed Sep. 30, 2014, and of U.S. patent application Ser. No. 14/525,449, filed Oct. 28, 2014. The entirety of each these priority applications is incorporated herein by reference.

### BACKGROUND

Various types of sensors are used in devices such as ultrasonic thickness gages, temperature gages, gas sensors, etc., for non-destructively measuring a characteristic of a test piece. Sensor devices are available in many different form factors, with smaller portable devices being useful where mobility is needed to transfer the sensor between different test pieces. However, the portability of these gauges is often offset by limitations in their capabilities. Such limitations include computing power, battery life, and display size. One way to address these challenges is to provide more powerful and efficient processors, higher-capacity batteries, and higher-resolution displays. However, a conservation of these resources may be beneficial, for example, from a cost standpoint. Moreover, different types of sensors may needed to take different types of measurements (i.e., temperature measurements require a temperature gauge, not a thickness gauge). Thus, users are often forced to carry several different sensors when, for example, conducting a walk-around inspection of an industrial facility.

In addition, the material from which the test piece is constructed, as well as its geometry, surface roughness, internal cracking, etc., may influence sensor calibration and/or sensor selection. Accordingly, calibration, especially when considering multiple different test pieces during a walk-around, may be cumbersome.

Further, some measurements are best performed over an extended period of time. For example, intermittent failures may occur infrequently, making detection and diagnosis difficult. Additionally, device characterization may require long-term measurements over a prolonged time period. Thus, a sensor device that is capable of monitoring a test device and logging data over an extended period of time would be desirable.

### SUMMARY

An embodiment may provide a sensor system for measuring one or more characteristics of a test piece. The sensor system may include a mobile unit including a sensory head that is detachable from the mobile unit. The sensory head may include at least one sensor, an identification reader configured to acquire data representing an identifier from an identification tag, and circuitry coupled with the at least one sensor and the identification reader. In response to the identification reader acquiring the data representing the identifier, the circuitry causes the at least one sensor to measure the at least one characteristic of the test piece while the sensory head is detached from the mobile unit.

An embodiment may further provide a method for measuring one or more characteristics of a test piece. The method may include attaching a sensory head to a mobile unit, wherein the sensory head comprises at least one sensor, and placing the sensory head in proximity to the test piece. While the sensory head is in proximity to the test piece, the mobile unit is detached from the sensory head. One or more measurements are preformed on the test piece using the at least one sensor to obtain measurement data while the sensory head is detached from the mobile unit. Subsequent to performing the one or more measurements on the test piece using the at least one sensor, the sensory head is attached to the mobile unit.

### BRIEF DESCRIPTION OF THE DRAWINGS

The accompanying drawings, which are incorporated in and constitute a part of this specification, illustrate an embodiment of the present teachings and together with the description, serves to explain the principles of the present teachings. In the figures:

FIG. 1A illustrates a schematic, perspective view of a sensor system, according to an embodiment.

FIG. 1B illustrates a schematic view of the sensor system, according to an embodiment.

FIG. 2 illustrates an exploded, perspective view of a sensory head, according to an embodiment.

FIG. 3 illustrates an exploded perspective view of contacts and an isolator ring of the sensory head, according to an embodiment.

FIG. 4 illustrates a perspective view of a body shell of the sensory head, according to an embodiment.

FIG. 5 illustrates a perspective view of a controller of the sensory head, according to an embodiment.

FIG. 6 illustrates an exploded, perspective view of a sensory head including two sensors and a hood according to an embodiment.

FIG. 7 illustrates a flowchart of a method for sensing one or more characteristics of a test piece using a sensor apparatus having a mobile unit and a detachable sensory head.

It should be noted that some details of the figures have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawing. In the drawings, like reference numerals have been used throughout to designate identical elements, where convenient. In the following description, reference is made to the accompanying drawing that forms a part thereof, and in which is shown by way of illustration a specific exemplary embodiment in which the present teachings may be practiced. The following description is, therefore, merely exemplary.

In general, embodiments of the present disclosure provide a mobile unit having a sensory head. The sensory head can be electrically and mechanically coupled with a sensory head, and then detached from the mobile unit during measurements of a test piece using the sensory head. The sensory head provides at least one sensor for measuring at least one characteristic of a test piece as well as an identification reader, such as a radio-frequency identification (RFID) tag reader, to name one example. The reader may be configured to acquire an identifier (e.g., tag number) from an identification tag (e.g., RFID tag) positioned at a predetermined location in, on, or near to a test piece. The identifier may be linked in a database to material properties, calibration information, sensor-selection information, and/or the like, which may be related to the predetermined location of the identification tag. The mobile unit, or a remote computing device (e.g., a ruggedized, hand-held computing device) in communication with the mobile unit, may access the location-specific information, which it may use to calibrate or otherwise analyze measurements taken by the sensory head.

Furthermore, the sensory head may be configured to automatically take test piece measurements in response to reading an identifier from the identification tag. The data collected by the sensory head during measurement of the test piece may be transmitted to the mobile unit and/or the remote device for displaying, processing, storage, etc., e.g., in association with the identifier.

The mobile unit may be provided with an electro-mechanical interface with the sensory head. The interface may be configured to support a connection with the sensor(s) of the sensory head thereby, for example, providing a modular extensibility for the mobile unit. Further, the sensory head may be detached from the mobile unit during measurements of a test piece. The sensory head is self-powering through a power source one or within the sensory head. As such, the interface may allow a sensory head to remain attached to a test piece during long-term measurements of the test piece.

One advantage of having the sensor(s) and identification reader close together (e.g., co-located in the sensory head) is that the identification tag may be mounted at the measurement location on or near the test piece, and the identification tag may be scanned to start the measurement. The sensory head may thus receive data representing the general physical location of the sensory head relative to the position of the test piece, and the logical measurement settings and alarm criteria associated with the test piece at the measurement location. It will be appreciated that these advantages and/or others may be provided in various embodiments of the present disclosure; however, these advantages should not be considered limiting or otherwise required.

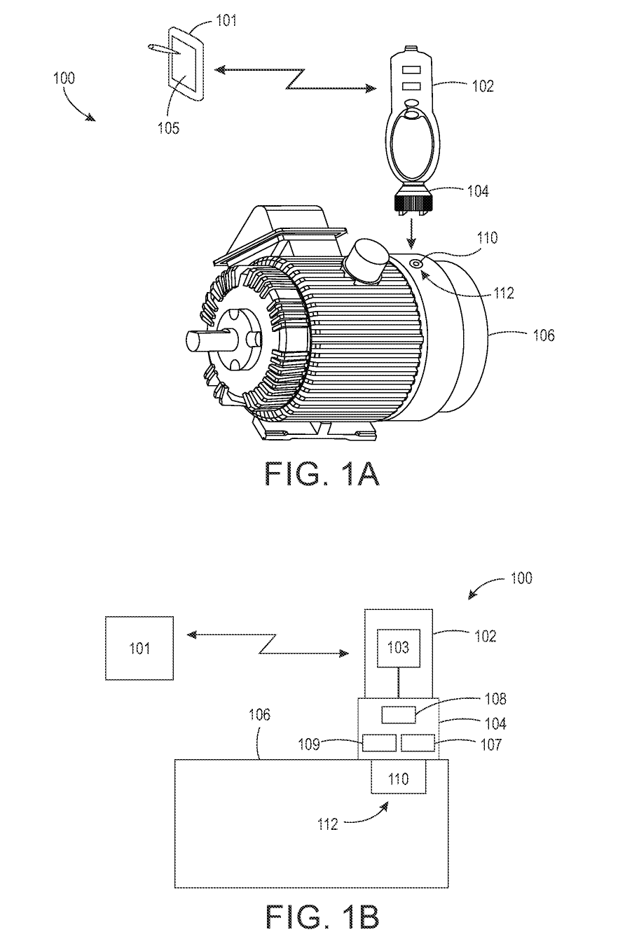

Turning now to the Figures, FIG. 1A illustrates a schematic, perspective view of a sensor system 100, according to an embodiment. FIG. 1B illustrates a simplified, schematic view of the sensor system 100, according to an embodiment. Referring to both FIGS. 1A and 1B, the sensor system 100 may include a mobile unit 102 that is in communication with a remote device 101 and in electrical and mechanical communication with a sensory head 104. The mobile unit 102 may include a power source 103, which may be a battery or a wired connection to an external power source, and may also include various other electrical and/or mechanical components.

The remote device 101 may be a portable electronic device, such as a smartphone, tablet, or laptop computer, or may be another type of specific or general-purpose computing device that is supplied with appropriate software. The mobile unit 102 may communicate with the remote device 101, and, in some embodiments, vice versa, via any suitable communications link, such as a wireless link (e.g., BLUETOOTH®, WiFi, WIMAX®, GSM, CDMA, LTE, etc.).

The sensor system 100 may also include a sensory apparatus or “head” 104 that may be releasably coupled, e.g., mechanically and electrically, with the mobile unit 102 so as to be positionally fixed thereto, receive at least power therefrom, and provide one or more signals thereto. The sensory head 104 may include, for example, at least one sensor 107. For illustration, FIG. 1B depicts a sensory head 104 including first sensor 107 and a second sensor 109, and the embodiments are generally described below with reference to two sensors, but it will be understood that a sensory head in accordance with an embodiment may include any number of sensors. The sensors 107, 109 may be any type of sensor for measuring one or more characteristics of a test piece 106, for example vibration sensors, thickness sensors such as ultrasonic thickness sensors, temperature sensors such as thermocouples or infrared sensors, gas detection sensors, etc. The first sensor 107 may be the same or different than the second sensor 109 as described below.

In at least one embodiment, the mobile unit 102 may include a display screen 105, which may be configured to display data based on the measurements taken using the sensory head 104. In other embodiments, the display screen 105 may be omitted from the mobile unit 102, or may otherwise not display such data.

The test piece 106 may be any portion of a machine, housing, or casing thereof, for example. In at least one specific example, the test piece 106 may be a bearing housing. Accordingly, the sensor system 100, e.g. via the sensory head 104 of the mobile unit 102, may be configured to determine a characteristic of the test piece 106, which may provide information as to system integrity, health, wear indication, etc.

Further, the sensory head 104 may include an identification reader 108. The identification reader 108 may be configured to capture data representing an identifier, such as a tag number, and/or any other information from an identification tag 110 mounted in, on, or near to, or otherwise disposed proximal to, a test location 112 of the test piece 106.

In some embodiments, the identification reader 108 may be a radio-frequency identification (RFID) tag reader, and the identification tag 110 may be an active or passive RFID tag. As the term is used herein, “tag” broadly refers to any structure that may be located in, on, or near to a test piece, and should not be interpreted as requiring any particular size or shape, unless otherwise expressly stated herein. In some embodiments, the tag 110 may be a small, thin structure made of one or several layers of material, which may be adhered to the location 112. In other embodiments, the identification tag 110 may be larger, include other components (such as a processor, display screen, other input and/or output peripherals, etc.), and/or may be incorporated into a larger device. In some embodiments, the identification tag 110 may display a quick response (QR®) code, whether statically (e.g., printed) or dynamically (e.g., displayed on a display screen). In another embodiment, the identification tag 110 may display a bar code, or may provide an identifier to the identification reader 108 through any other medium, such as sound, light (e.g., infrared) pulses, etc. The identification reader 108 may be suitably configured to read the QR code, bar code, or any other identifier transmission medium selected.

The identifier read from the identification tag 110 may be associated with location-specific information, e.g., in a table or database. The database may be stored on the mobile unit 102, on the remote device 101, or on another device communicably coupled with the mobile unit 102 and/or the remote device 101. For example, the location-specific information may include the material composition, surface roughness, geometry, or any other property of the test piece 106 that may assist in selecting a sensor, calibrating the sensor, and/or analyzing the measurement data. In an embodiment, the location-specific information may additionally or instead represent historical thickness measurements at the test location 112. Such historical measurements may facilitate the calculation of measured thickness trends, which may contribute to life-cycle analysis, wear-rate determinations, system health, etc.

The sensory head 104 may be a modular unit, which may be removable from the mobile unit 102. Accordingly, when a different sensory head is needed, the sensory head 104, including the first sensor 107 and second sensor 109, may be removed from the mobile unit 102, and another sensory head attached. This may facilitate switching between different types of sensors while testing various equipment in an industrial facility.

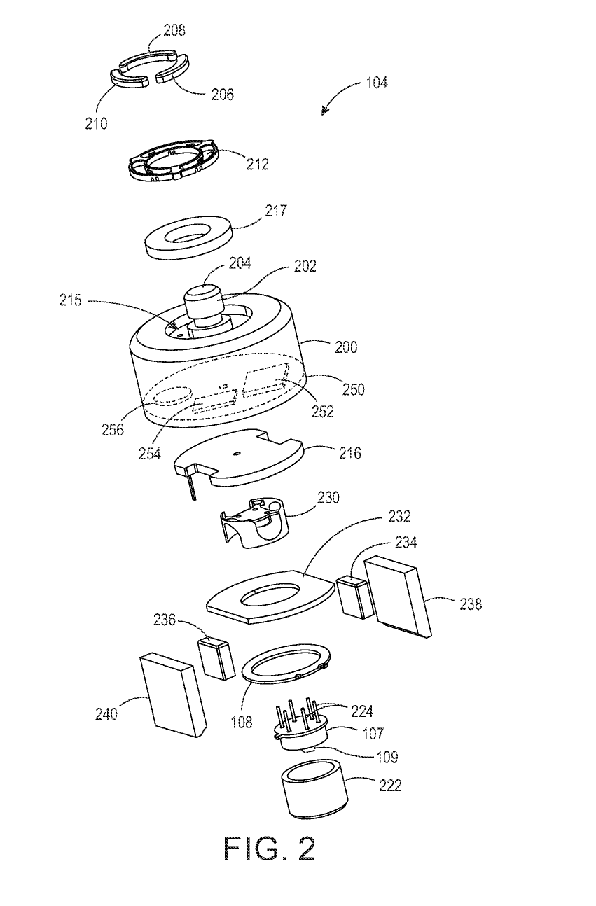

FIG. 2 illustrates an exploded view of the sensory head 104, according to an embodiment. It will be appreciated that the sensory head 104 displayed in FIG. 2 is but one specific example among many contemplated. As shown, the sensory head 104 includes a body shell 200, which may provide a rugged exterior for the sensory head 104. The sensory head 104 may also include a mounting device 202, such as a threaded stud, “quick-release” shaft, threaded opening, quick-release shaft collar, tabs, magnet, or any other device for mounting the sensory head 104 to the mobile unit 102. Accordingly, the mobile unit 102 (e.g., FIG. 1) may include a receptacle, such as a female threaded connection, quick connect shaft or collar, magnet, etc., for receiving and coupling with the mounting device 202.

The sensory head 104 may also include a ground connection 204, which may be integrated into the mounting device 202. The ground connection 204 may be electrically connected with the mobile unit 102. Accordingly, using the mounting device 202, the sensory head 104 may be placed into electro-mechanical communication with the mobile unit 102 and/or quickly removed from such communication therewith.

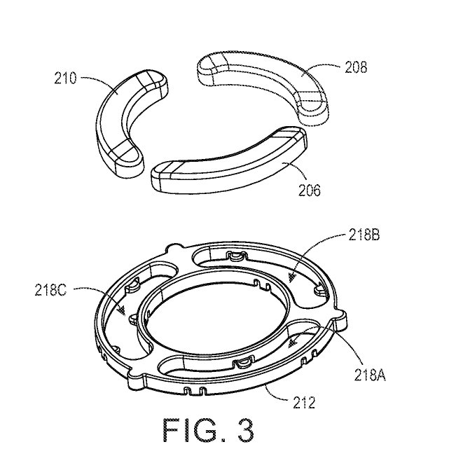

Several elements of the sensory head 104 embodiment depicted in FIG. 2 will now be described with reference to enlarged views thereof provided in FIGS. 3-6. Reference is thus made to each of FIGS. 3-6 individually, with continuing reference to the context provided by the illustrated embodiment of FIG. 2.

The sensory head 104 may include at least one contact (three are shown: 206, 208, 210) and an isolator ring 212. FIG. 3 illustrates an enlarged, perspective view of the contacts 206-210 and the isolator ring 212, according to an embodiment. As shown, the contacts 206-210 may be formed as arc-shaped members. The isolator ring 212 may include slots 218A, 218B, 218C, which may receive the contacts 206-210, respectively. The isolator ring 212 may thus serve to electrically isolate the contacts 206-210 from one another.

In an embodiment, the contact 206 may be configured to deliver power from the mobile unit 102 to the sensory head 104. The contact 208 may be configured to deliver a digital input signal from the mobile unit 102 to the sensory head 104. The contact 210 may be configured to deliver a digital output signal to the mobile unit 102, e.g., based on a signal from the sensory head 104. Although not depicted, in another embodiment, a fourth contact may be provided and seated within a slot of the isolator ring 212, for providing a communication signal from an identification reader (e.g., antenna) to the mobile unit 102, as will be described below.

FIG. 2 further depicts circuitry 250 such as a printed circuit board (PCB) or flexible printed circuit (flex circuit), one or more logic devices 252 such as a microprocessor and/or other logic devices, one or more memory devices 254, and one or more power source 256 such as one or more batteries or supercapacitors. The power source 256 can provide power to the logic device 252, memory device 254, and circuitry 250 to enable their operation in the absence of power from another source such as the power source 103 in the mobile unit 102. While FIG. 2 depicts the circuitry 250 being separate from a controller 216, it will be appreciated that the circuitry 250, logic device 252, memory device 254, and power source 256 may be integrated within the controller 216 itself. Further, the circuitry 250, logic device 252, memory device 254, and power source 256 may be positioned at some other location on or within the sensory head 104.

In this embodiment, the mobile unit 102, and particularly the sensory head 104 of the mobile unit 102, can be placed in proximity to the test piece 106, so as to measure one or more electrical and/or physical characteristics thereof, as described above. Subsequently, with the sensory head 104 in communication with the test piece 106, the sensory head 104 may be detached from the mobile unit 102. With the sensory head 104 detached from the mobile unit 102, the sensory head can operate to take measurements from the test piece 106 over an extended period of time, powered by the power source 256 on or within the sensory head 104.

In an embodiment, measurements can be stored as measurement data within the memory device 254 until the data are uploaded to the mobile unit 102 and/or remote device 101, or another receiver, after removal of the sensory head 104 from the test piece 106. In another embodiment, the data can be transmitted wirelessly, either continuously or periodically, to the mobile unit 102 and/or the remote device 101 while the sensory head 104 is in communication with the test piece 106 using a wireless transmitter within the sensory head 104. The wireless transmitter may be part of the circuitry 250. After completion of measurements, the mobile unit 102 may be reattached to the sensory head 104 and the sensory head 104 is removed from communication with the test piece 106.

The one or more sensors 107, 109 may take measurements from the test piece 106 continuously or periodically. In an embodiment, continuous measurements from the test piece 106 can provide operational data for characterizing operational characteristics of the test piece 106 during normal operation. Continuous measurements may also assist with troubleshooting of the test piece 106, for example by providing operational data over an extended period of time to diagnose intermittent failures or other operational anomalies.

The one or more logic devices 252 can be designed to control operation of the circuitry 250 and memory 254 to log data continuously during measurements, or to log data only when certain operational triggers of the test piece 106 are detected. The first sensor 107 may be a first type of sensor, such as a rotational speed sensor, that detects a rotational speed of the test piece 106. The second sensor 109 may be a second type of sensor different from the first type of sensor 107, for example a vibration sensor. The logic device 252 can selectively enable the first sensor 107 and thereby cause the first sensor 107 to monitor the rotational speed of the test piece 106 without causing measurement data to be written to the memory 254. While the rotational speed of the test piece 106 is below or above a target minimum or maximum, or outside a target range, the logic device 252 can further selectively disable operation of the second sensor 109 to reduce usage of power from the power source 256. Once a trigger rotational speed is detected by the circuitry 250, the logic device 252 can power and thereby selectively enable the second sensor 109 to sense a vibration of the test piece 106, and to selectively commence data logging to the memory 254 for later uploading and analysis. In another embodiment, the logic device 252 can selectively enable the one or more sensors at an arbitrary time interval “T” and log data for an arbitrary time interval “Y.” In another embodiment, the logic device 252 can selectively enable the one or more sensors at an arbitrary time interval “T,” log data for as long as the operational characteristic of the test piece 106 is above or below a predefined minimum or maximum, for example above or below a predefined vibrational threshold.

Thus a sensory head 104 may remain in communication with, or otherwise attached to, a test piece 106 for an extended period of time. The sensory head 104 remains active for part, or all, of the time it is attached to the test piece. Since the sensory head 104 need not be attached to the mobile unit 102 during this time, any harsh operational conditions that may negatively affect the performance of the mobile unit 102, for example electronics within the mobile unit 102, are avoided. The mobile unit 102 may be used with other sensory heads 104 during this time, thereby decreasing equipment costs. Additionally, the ability to perform measurements on the test piece 106 over an extended time period may assist with diagnosing a test piece that has intermittent failures or other operational anomalies, and with characterizing the operation of test piece that is functioning normally.

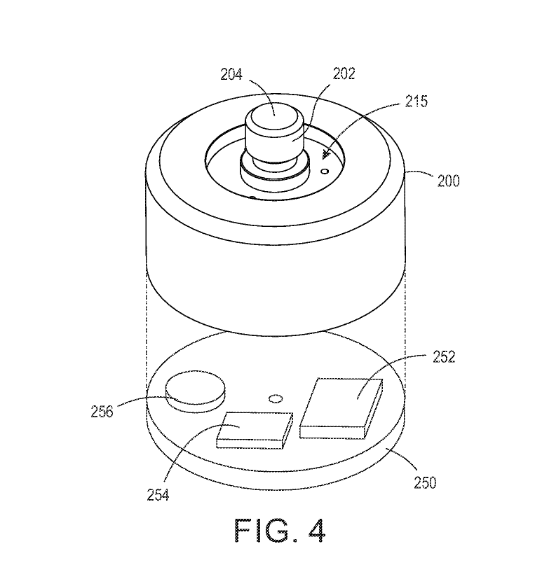

FIG. 4 illustrates an enlarged, perspective view of the body shell 200, according to an embodiment. As mentioned above, the body shell 200 may include the mounting device 202 and the ground connection 204. The body shell 200 may also include a recess 215, which may be defined at least partially around the mounting device 202. The contacts 206-210 and the isolator ring 212 may seat in the recess 214; however, in other embodiments, the contacts 206-210 and body shell 200 may be coupled together, or otherwise positioned, in any other manner. Further, the contacts 206-210 and isolator ring 212 may be disposed in or “potted” in a resin 217, or another material, which may provide a stable and, for example, electrically insulating mount for the contacts 206-210 and isolator ring 212 in the recess 215.

The sensory head 104 may further include the first sensor 107, the second sensor 109, and a hood 222. The hood 222 may cover at least a portion of the sensors 107, 109, thereby shielding them from the surrounding environment. FIG. 6 illustrates an enlarged, exploded, perspective view of the sensors 107, 109 and the hood 222, according to an embodiment. While FIG. 6 depicts one particular form factor including the first sensor 107 and the second sensor 109, it will be appreciated that other form factors for two or more sensors are contemplated depending on the design and/or use of the sensory head 104.

As shown, the first sensor 107 and the second sensor 109 may be physically coupled with at least one of a plurality of leads 224. For example, the sensors 107, 109 may receive power and/or one or more digital communication signals via the leads 224 and provide a digital signal via another one of the leads 224. The leads 224 may, in turn, be electrically connected with a controller 216 and/or the contacts 206-210, and eventually with the mobile unit 102 (FIG. 1). One or more of the leads 224 are further electrically coupled with the power source 256 to power the sensors 107, 109 during operation while the sensory head 104 is disconnected from the mobile unit 102. During attachment of the sensory head 104 to the mobile unit 102, one or more leads may be connected to a power source within the mobile unit 102, for example to conserve power within the power source 256. During connection between the mobile unit 102 and the sensory head 104, power from the power source 103 within the mobile unit 102 may be used to charge the power source 256 within the sensory head 104. While six pin-style electrical leads 224 are depicted in FIG. 2, it will be appreciated that any number and any style of leads 224 may be used, depending on the design and intended use of the mobile unit 102 (FIG. 1A) and sensory head 104. A first portion of the leads 224 provides input to, and/or output from, the first sensor 107, while a second portion of the leads 224 provides input to, and/or output from, the second sensor 109. As indicated above, only one sensor, or more than two sensors, within the same sensory head 104 (FIG. 1) are contemplated. In an embodiment, two sensors may measure the same test piece characteristic wile a third sensor measures a different test piece characteristic.

Referring now again specifically to FIG. 2, the sensory head 104 may also include an identification reader 108. The identification reader 108 may be configured to detect an identifier from the identification tag 110 (FIG. 1), as noted above. Accordingly, in an RFID embodiment, the identification reader 108 may be an RFID antenna (e.g., an active or passive RFID reader), and may include a tuned, wire loop, which may receive a modulated radio frequency signal from the RFID tag. The received radio frequency signal may provide data representing the identifier associated with the RFID tag. In active-reader embodiments, the identification reader 108 may also transmit a signal to the RFID tag, providing the energy for the signal carrying the identifier. In other embodiments, the identification reader 108 may be an optical sensor, which may read a QR code or a bar code provided by the identification tag 110, or may be any other type of sensor configured to receive information from the identification tag 110. In an embodiment, at least one of the contacts 206-210 may transmit the read tag information through a digital output signal, and out of the sensory head 104 into the mobile unit 102.

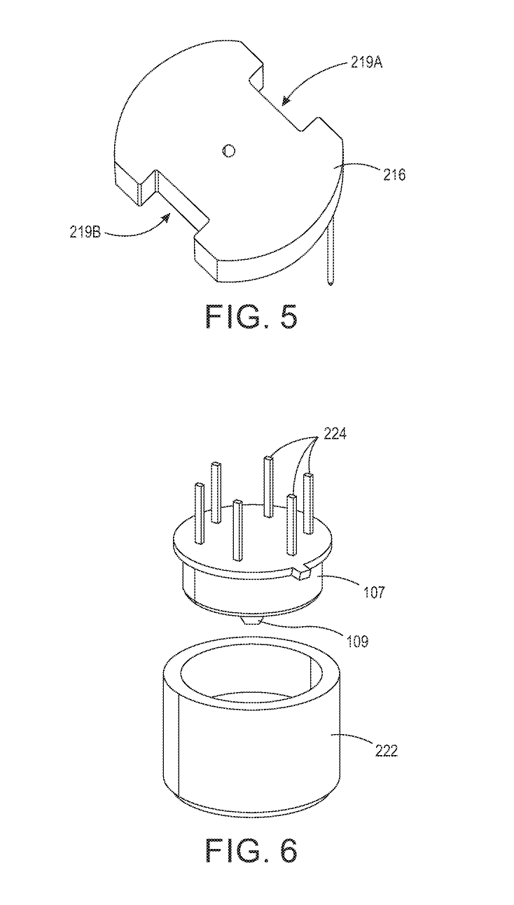

The controller 216, coupled with the leads 224 as noted above, may control operation of, including the power supply to, the sensory head 104, among other functions. FIG. 5 illustrates an enlarged view of the controller 216, according to an embodiment. The controller 216 may be or include one or more printed circuit boards (PCBs). In at least some embodiments, the controller 216 may include one or more microprocessors, electrical contacts/leads, electrical pathways, etc. The controller 216 may be in electrical communication with one or more of the contacts 206-210, as well as the ground connection 204.

Further, the controller 216 may define one or more magnet slots 219A, 219B, which may be formed as cut-outs extending inwards from the periphery of the controller 216. The controller 216 may be configured to selectively power the various elements of the sensory head 104, receive information therefrom, transmit information to the mobile unit 102, and/or otherwise control a functioning of the sensory head 104.

The sensory head 104 may also include a support assembly for the identification reader 108. For example, the support assembly may include a reader spacer 230 around which the identification reader 108 (e.g., a loop-shaped antenna) may be received, and a reader plate 232, which may couple with the identification reader 108 and the controller 216, so as to position the identification reader 108 with respect thereto. In some embodiments, however, the identification reader 108 may be or include an RFID spiral antenna or a wound inductor antenna, which may be coupled with the reader plate 232.

The sensory head 104 may also include one or more mounting feet (two are shown: 238, 240). The mounting feet 238, 240 may be fabricated at least partially of a highly-permeable material, which may transmit the magnetic flux generated by magnets 234, 236. Further, the mounting feet 238, 240 may, in at least some embodiments, extend beyond the hood 222 so as to physically contact the test piece 106. In other embodiments, the mounting feet 238, 240 may not extend past the hood 222 and may, instead, be housed therein, transmitting the magnetic flux therethrough. Moreover, it will be appreciated that the magnets 234, 236 and/or mounting feet 238, 240 may be provided in any suitable shape and configuration, with the illustrated embodiment being merely one among many contemplated. Furthermore, in some embodiments, the magnets 234, 236 may be configured to bear directly on the test piece 106, with the mounting feet 238, 240 being omitted. In still other embodiments, the magnets 234, 236 and the mounting feet 238, 240 may be unnecessary and omitted.

Referring again to FIGS. 1 and 2, in an example of operation, the mobile unit 102 may be brought into proximity of the identification tag 110 (e.g., RFID tag). The identification reader 108 may read an identifier from the identification tag 110. For example, the identification reader 108 may poll for identification tags to read, e.g., by sending a signal constantly or intermittently. A preliminary trigger may also be provided to initiate such polling, such as a signal from the remote device 101, the controller 216 detecting the magnets 234, 236 engaging the test piece 106, or another trigger. In other embodiments, the identification reader 108 may be energized manually via user input to seek an identification tag 110 to read (e.g., to begin transmitting an energizing radio-frequency signal). In still other embodiments, the identification reader 108 may automatically detect proximity to an identification tag 110 in any other way.

The controller 216 may detect when the identification reader 108 reads a signal from the identification tag 110. In response, the controller 216 may cause the sensors 107, 109 to begin the measurement process appropriate for the type of sensor. In a specific embodiment, the controller 216 may provide power to the first sensor 107 and the second sensor 109 and receive data therefrom, e.g., via the leads 224. In some embodiments, the controller 216 may be operable independently to cause the sensors 107, 109 to commence measuring. In other embodiments, the controller 216 may interface with a separate controller housed in the mobile unit 102, the remote device 101, or elsewhere, for initiation of the measuring of the characteristic.

In some embodiments, in addition to or instead of initiating measurement when the identification reader 108 reads an identifier, the controller 216 may be configured to detect when the magnets 234, 236 magnetically engage the test piece 106, e.g., via the mounting feet 238, 240. In some embodiments, the controller 216 (or another part of the mobile unit 102 and/or remote device 101) may be responsive to a user input, e.g., a user pressing a button on the mobile unit 102 and/or remote device 101, and may initiate thickness measurements in response to such manual input.

When the identification reader 108 obtains an identifier from the identification tag 110, the sensory head 104 (e.g., the controller 216) may provide a signal to the mobile unit 102 that includes a digital representation of the identifier. The mobile unit 102 may, in some embodiments, relay the identifier to the remote device 101. In some embodiments, the remote device 101 and/or the mobile unit 102 may query a database, using the obtained identifier, so as to determine the location-specific information associated with the test location 112 of the test piece 106. The mobile unit 102 and/or the remote device 101 may then use this information to assist in calibration of sensor data, and/or analysis thereof.

Furthermore, the recorded measurement(s) from the sensors 107, 109 may be stored in association with the identifier. The identifier, which may be linked to a machine and/or the specific location 110, may thus provide an index to a history of measurements, which may be updated each time the thickness of the test piece 106 is measured in response to a particular identifier being read.

In an embodiment, the physical connection and/or the electrical connection between the mobile unit and the sensory head may be releasable without damaging either. For example, multiple sensory heads, e.g., with multiple different types and/or sizes of sensors may be provided as modular units.

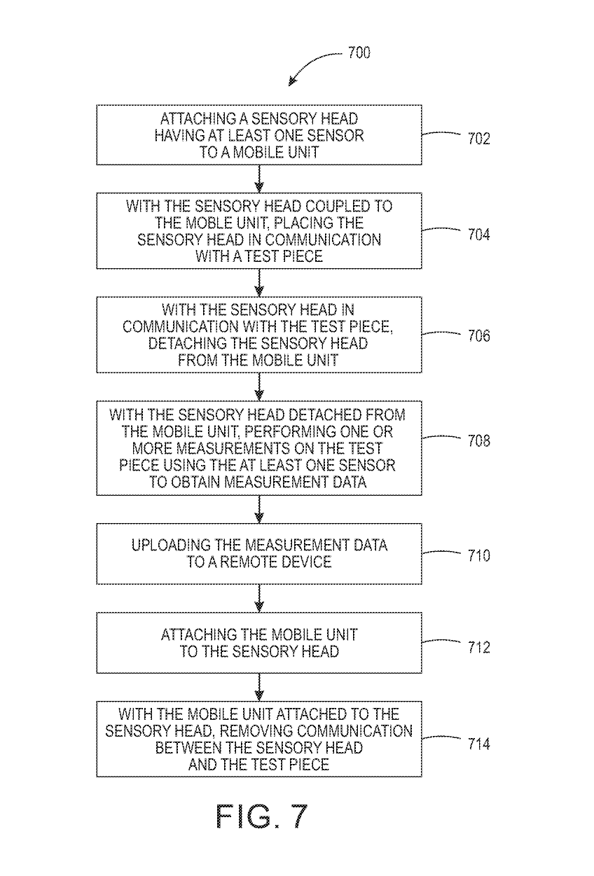

FIG. 7 is a flow chart depicting a method 700 that includes the use of a sensory head 104 that is operational during detachment from the mobile unit 102. At 702, a sensory head, such as sensory head 104 having one or more sensors, is coupled to a mobile unit. With the sensory head coupled to the mobile unit, the sensory head is placed in communication with the test piece as shown at 704. The communication can be a physical connection in which the sensory head is attached to, or brought into proximity of, the test piece as depicted in FIG. 1A, and/or an electrical communication in which the sensory head is in electronic communication with the test piece. With the sensory head in communication with the test piece, the sensory head is detached from the mobile unit as shown at 706. At 708, with the sensory head detached from the mobile unit, one or more measurements are performed on the test piece using the at least one sensor to obtain measurement data. After collecting the measurement data, the measurement data is uploaded to a remote device 710, which may be the mobile unit 102, remote device 101, or another remote device. Data uploading may be performed at this point in the process, or another point after the data is collected.

After collecting the data, the mobile unit is attached to the sensory head while the sensory head is in communication with the test piece 712, then the sensory head is removed from communication with the test piece while attached to the mobile unit as shown at 714.

While the present teachings have been illustrated with respect to one or more implementations, alterations and/or modifications may be made to the illustrated examples without departing from the spirit and scope of the appended claims. It will be appreciated that while a process is described as a series of acts or events, the embodiments are not limited by the ordering of such acts or events. Some acts may occur in different orders and/or concurrently with other acts or events apart from those described herein. Also, not all process stages may be required to implement a methodology in accordance with one or more aspects or embodiments of the present teachings, and additional processing stages may be incorporated. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A sensor system for measuring one or more characteristics of a test piece, the sensor system comprising:
a mobile unit; and
a sensory head that configured to be electrically and mechanically coupled with the mobile unit, and removable therefrom, wherein the sensory head comprises:
at least one sensor;
an identification reader configured to acquire data representing an identifier from an identification tag; and
circuitry coupled with the at least one sensor and the identification reader, wherein, in response to the identification reader acquiring the data representing the identifier, the circuitry causes the at least one sensor to measure the at least one characteristic of the test piece while the sensory head is detached from the mobile unit.

2. The sensor system of claim 1, wherein the identification reader comprises a radio-frequency identification (RFID) antenna.

3. The sensor system of claim 1, wherein the identification reader comprises a bar-code scanner, a quick response code scanner, or a combination thereof.

4. The sensor system of claim 1, further comprising a body shell into which the identification reader and the circuitry are at least partially received, the body shell comprising a mounting device configured to be removably coupled with a mobile unit.

5. The sensor system of claim 4, wherein the body shell defines a recess therein, the sensor system further comprising one or more electrical contacts received into the recess and electrically coupled with the circuitry, the one or more electrical contacts being configured to electrically communicate with the mobile unit, when the mounting device is coupled therewith.

6. The sensor system of claim 5, wherein the recess extends at least partially around the mounting device.

7. The sensor system of claim 1, further comprising one or more magnets, the one or more magnets being configured to mechanically engage the test piece.

8. The sensor system of claim 7, wherein the circuitry is configured to detect when the one or more magnets magnetically engage the test piece.

9. The sensor system of claim 1, wherein:
the at least one sensor comprises at least a first sensor and a second sensor;
the circuitry is configured to disable operation of the second sensor during operation of the first sensor; and
the circuitry is further configured to enable operation of the second sensor during operation of the first sensor.

10. The sensor system of claim 9, wherein the circuitry:
further comprises at least one memory device;
is further configured to enable storage of measurement data within the memory device while operation of the second sensor is enabled by the circuitry; and
is further configured to disable storage of the measurement data while operation of the second sensor is disabled by the circuitry.

11. The sensor system of claim 10, wherein the circuitry:
is configured to enable the first sensor and the second sensor for a first period of time, and to enable storage of measurement date while the first sensor and the second sensor are enabled; and
is configured to disable the first sensor and the second sensor for a second period of time, and to disable storage of measurement data while the first sensor and the second sensor are disabled.

12. A method for measuring one or more characteristics of a test piece, comprising:
attaching a sensory head to a mobile unit, wherein the sensory head comprises at least one sensor;
placing the sensory head in proximity to the test piece;
while the sensory head is in proximity to the test piece, detaching the mobile unit from the sensory head;
enabling the at least one sensor and performing one or more measurements on the test piece using the at least one sensor to obtain measurement data while the sensory head is detached from the mobile unit; and
subsequent to performing the one or more measurements on the test piece using the at least one sensor, attaching the sensory head to the mobile unit.

13. The method of claim 12, wherein the sensory head further comprises a memory device and the method further comprises storing the measurement data within the memory device.

14. The method of claim 13, further comprising uploading the measurement data from the memory device to a remote device.

15. The method of claim 13, further comprising disabling operation of the at least one sensor while the sensory head is detached from the mobile unit.

16. The method of claim 12, further comprising:
enabling operation of the at least one sensor for a first timed period; and
disabling operation of the at least one sensor for a second timed period.

17. The method of claim 12, further comprising:
transmitting an identifier from the test piece to an identification reader within the mobile unit; and
in response to the identification reader acquiring the identifier, initiating the performing of the one or more measurements on the test piece using the at least one sensor to obtain a measurement.

18. The method of claim 17, further comprising acquiring the identifier using a radio-frequency identification (RFID) antenna within the sensory head.

19. The method of claim 17, further comprising acquiring the identifier using a bar-code scanner, a quick response code scanner, or a combination thereof.

20. The method of claim 12, wherein the at least one sensor comprises a first sensor and a second sensor, and the method further comprises:
enabling operation of the first sensor while the sensory head is detached from the mobile unit; and
disabling operation of the second sensor such that the second sensor is disabled during the operation of the first sensor.
